(19) United States
(12) Patent Application Publication
(10) Pub. No.: US 2019/0203748 A1
(43) Pub. Date: Jul. 4, 2019

(54) System for Creating Water Vortices inside Eight-Shaped Pipe

(71) Applicants: Sigal Geshuri, Ramat Gan (IL); Saar Ben Yosef, Petah Tikva (IL); Rami Widra, Petah Tikva (IL)

(72) Inventors: Sigal Geshuri, Ramat Gan (IL); Saar Ben Yosef, Petah Tikva (IL); Rami Widra, Petah Tikva (IL)

(21) Appl. No.: 16/237,686

(22) Filed: Jan. 1, 2019

(30) Foreign Application Priority Data
Jan. 2, 2018 (IL) 256696

(51) Int. Cl. F15D 1/00; F16L 9/00

(52) U.S. Cl. CPC F15D 1/0015; F16L 9/00

(57) ABSTRACT

A system for creating water vortices in water pipes that includes housing that contain an eight-shaped copper pipe, which has an inlet opening and an outlet opening with connectors that are designed to connect the eight-shaped copper pipe to the water pipe. The eight-shaped copper pipe includes three or more crushed areas for spinning and whirling the water. The system may include a gold element, a silver element, copper foils, crystals, religious elements, words from the Kabala, and tubes filled with water from three specific special sources.

### TECHNICAL FIELD

The present invention refers to a system for creating water vortices inside eight-shaped pipe that is designed to be connected to a household pipe.

### BACKGROUND ART

Many people are interested to create water vortices inside their household pipe, based on believes that such vortices improve the quality of the water for many purposes such as drinking and even irrigation. Few of these believe have for some extent a research support. The present patent application discloses a system for creating water vortices inside the houses pipes.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts the copper pipe (3) and its elements.

FIG. 2 depicts the housing (2), in opened state, when and the copper pipe (3) is positioned inside it.

FIG. 3 depicts schematically the system (1) wherein the housing (2) includes those additional elements (51)-(57).

### THE INVENTION

The object of the present invention is to provide a system (1) for creating water vortices inside the houses pipes. The target of the system is to spinning and splashing the water in pipes of the house and to cause to water vortices, based on the opinion of many people that such action improves the water. In addition, many people hold the opinion that some kinds of elements add to water some qualities, and therefore the system subject matter of the present patent application may include such elements.

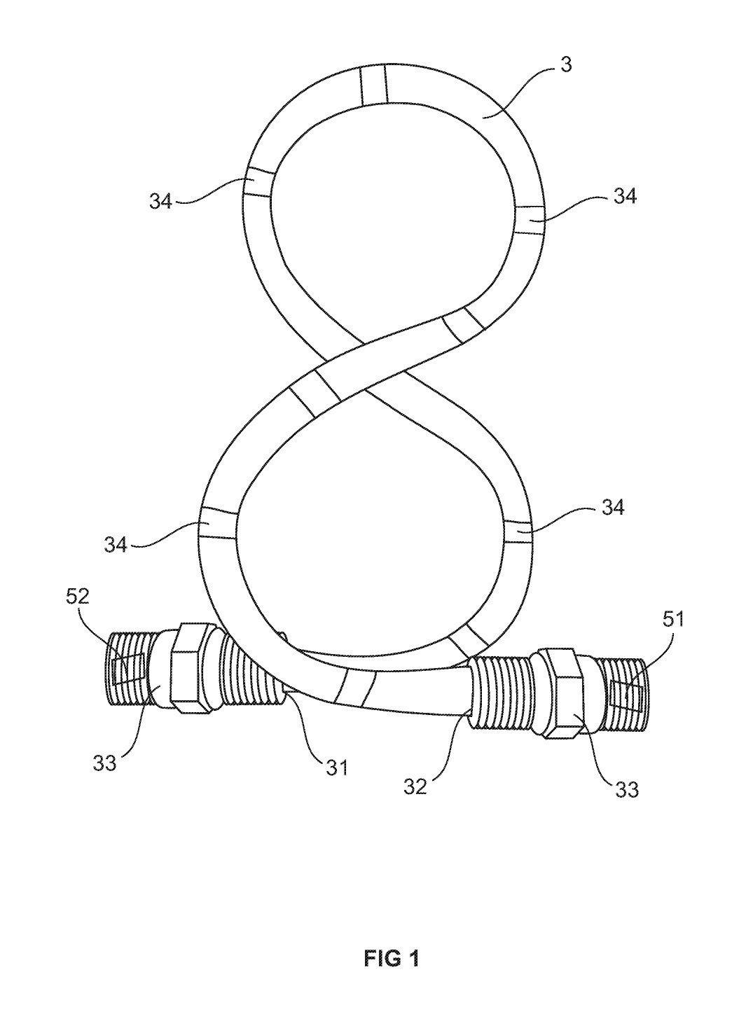

The system (1) for creating water vortices in the houses pipes includes housing (2) and an eight-shaped copper pipe (3) that has an inlet opening (31) and an outlet opening (32). The inlet opening (31) and the outlet opening (32) includes connectors (33), enabling to connect the eight-shaped copper pipe (3) to the water pipe of the house (4). The eight-shaped copper pipe (3) is crushed along its length in three or more areas (hereinafter “the crushed areas” (34)), so that its inner diameter in the crushed areas (34) is narrower than the general inner diameter of the eight-shaped copper pipe (3). FIG. 1 depicts the eight-shaped copper pipe (3) and its elements.

The housing (2) includes two openings (21) for enabling to connect the inlet and the outlet openings (31) (32) of the eight-shaped copper pipe (3) to the water pipe of the house (4).

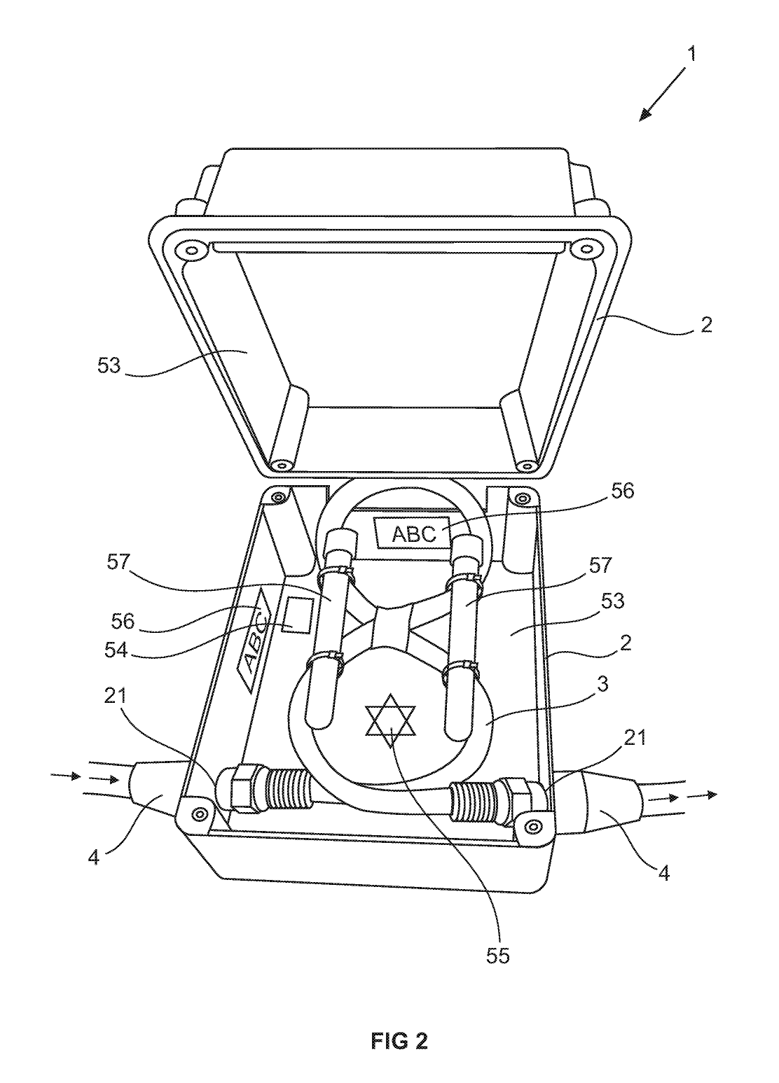

The housing (2) is designed to contain the eight-shaped copper pipe (3) and the eight-shaped copper pipe (3) itself is designed to be connected to the water pipe of the house (4). FIG. 2 depicts the housing (2), in opened state, when the eight-shaped copper pipe (3) is positioned inside.

When the water streams inside the eight-shaped copper pipe (3) it faces a narrow diameter and then wide diameter repeatedly several times, as the number of the crushed areas (34), and as a result of that the water spin and whirling through the narrow part into the wide part of the eight-shaped copper pipe. The water that streams through the eight-shaped copper pipe (3) circulates, spin and whirling due to the unique structure of the eight-shaped copper pipe that may results with decomposing the water scale.

The system (1) may include inside the housing (2) one or more of the following elements, that many people believe they improves the quality of the water that streams through the eight-shaped copper pipe (3).

A gold element (51) that may be designed as a ball made of fine silver, such as between 999 to 1000 purity, which is covered by pure gold, 24k and possible less. The gold element (51) may be positioned in one of the connectors (33).

A silver element (52) that may be designed as a ball made of fine silver, such as between 999 to 1000 purity, which may be positioned in the other connector (33). In this way, the water comes with contact with the gold element, the silver element and the copper of which the eight-shaped copper pipe (3) is made. There is a belief that when water comes with contact with these three metals they get higher energy. Copper foils (53) that cover the inner sides of the housing (2). The system (1) may also include inside its housing (2) crystals (54), religious elements (55), such as King David star, words from the Kabala (56), and one tube (57) or more filled with water from three special specific sources.

What is claimed is:

1. A system for creating water vortices in water pipe, comprising: housing and an eight-shaped copper pipe;
wherein said eight-shaped copper pipe has an inlet opening and an outlet opening, that includes connectors which are designed to connect the eight-shaped copper pipe to the water pipe; wherein the eight-shaped copper pipe includes three or more crushed areas; wherein the housing includes two openings whereby enabling to connect said inlet and outlet openings to the water pipe; wherein the housing is designed to contain the eight-shaped copper pipe.

2. The system for creating water vortices in water pipe according to claim 1 that further include one or more of the following elements: a gold element, a silver element, copper foils, crystals, religious elements, words from the Kabala, and one tube or more filled with water from three specific special sources.
